(19) United States
(12) Patent Application Publication
(10) Pub. No.: US 2021/0224912 A1
(43) Pub. Date: Jul. 22, 2021

(54) TECHNIQUES TO FORECAST FUTURE ORDERS USING DEEP LEARNING

(71) Applicant: State Street Corporation, Boston, MA (US)

(72) Inventors: Dajun Wang, Hangzhou, Zhejiang (CN); Xuefeng Liu, Hangzhou, Zhejiang (CN); Ji Zhou, Suzhou, Jiangsu (CN); Tianshi Wang, Hangzhou, Zhejiang (CN)

(21) Appl. No.: 16/767,332

(22) PCT Filed: Mar. 15, 2019
(86) PCT No.: PCT/CN2019/078239

§ 371 Date: May 27, 2020

(51) Int. Cl. G06Q 40/06; G06N 3/04; G06N 3/08

(52) U.S. Cl. CPC G06Q 40/06; G06N 3/08; G06N 3/04

(57) ABSTRACT

Techniques to use deep learning to forecast future orders for a financial service provider to execute by a future date. These techniques leverage a variety of features to predict an appropriate number of orders to execute, for example, on a next trading day. Some features correspond to market indices including their reconstitution schedule while others may correspond to historical orders by the financial service provider. By segregating the features and filtering individual features, these techniques are able to eliminate some noise and focus on a particular feature for insight into the future orders. Other embodiments are described and claimed.

### BACKGROUND

Companies and other organizations offer a variety of services for public and private consumption. Some of these services are economic services provided by the finance industry, encompassing a broad range of businesses that manage money, including credit unions, banks, credit-card companies, insurance companies, accountancy companies, consumer-finance companies, stock brokerages, investment funds, individual managers, and some government-sponsored enterprises. Asset management, an example service, can provide a service user with a number of benefits.

Proper asset management relies upon estimating/forecasting future orders with respect to the managed assets. Every trading day, asset managers of larger funds will adjust the expected position for each fund under predefined strategies. These adjustments are eventually split and/or aggregated into orders of suitable sizes for the asset managers to execute. Due to volatility in the financial markets, the number of orders to execute varies considerably over time and is hard to forecast. Making reliable predictions as to the number of orders to execute by a future date positively impacts the valuation of the managed assets and the performance of the asset managers. While many companies are devoting time and resources towards resolving these difficulties, conventional solutions are deficient for a number of reasons including an inadequate representation of the features affecting the data being forecasted.

It is with respect to these and other considerations that the present improvements have been desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to forecast future orders using deep learning. Some embodiments are particularly directed to techniques to forecast future orders using deep learning for a financial service provider. Some embodiments implement these techniques in an apparatus, a computer-implemented method, and a computer-readable storage medium. In one embodiment, an apparatus includes a processing circuit and logic stored in computer memory and executed on the processing circuit. The logic is operative to cause the processing circuit to process a feature set corresponding to historical data of a financial service provider. The feature set includes time series data for each feature of a plurality of features. At least one of the plurality of features corresponds to a market index and a reconstitution schedule over a time period. The logic is operative to cause the processing circuit to apply a filter on the time series data for each feature of the plurality of features. The filter includes at least one function configured to produce a set of filtered values of which each filtered value corresponds to a point-in-time in the time period. The logic is operative to cause the processing circuit to use a deep learning model to combine each set of filtered values for the feature set and determine a number of orders for the financial service provider to execute on a future date. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to forecast future orders using deep learning.

FIG. 2 illustrates an embodiment of an apparatus for the system of FIG. 1.

FIG. 3 illustrates an embodiment of a distributed model for the system of FIG. 1.

FIG. 4 illustrates an embodiment of forecasting method for the system of FIG. 1.

FIG. 5 illustrates an embodiment of a first logic flow for the system of FIG. 1.

FIG. 6 illustrates an embodiment of a second logic flow for the system of FIG. 1.

FIG. 7 illustrates an embodiment of a computing architecture.

FIG. 8 illustrates an embodiment of a communications architecture.

FIG. 9 illustrates an alternative embodiment of a computing architecture.

### DETAILED DESCRIPTION

Various embodiments are directed to forecasting future orders using deep learning. In some embodiments, a deep learning model (which is a type of machine learning model that implements a neural network architecture) is built and trained to include parameters for accurately predicting a number of orders for a financial service provider to execute at or by some future date. It is appreciated that the future date may be a next day, a next month, etc. along a time period. It is further appreciated that the above-mentioned orders are applicable to any financial product or asset. The deep learning model may leverage a plurality of features to make accurate predictions regarding the future orders. Among the plurality of features, at least two features correspond to a market index and a reconstitution schedule for updating the market index. Some embodiments incorporate historical order data as another feature. An example feature may include time series data representing historical (daily) orders by the financial service provider or historical (daily) weighted averages for the market index. Another example feature may include a value representing an importance or accuracy of a current reconstitution schedule on an optimal number of orders.

Some embodiments configure the deep learning model with appropriate parameters to operate on the above-mentioned features as input variables. Accordingly, some parameters refer to nodes in a deep learning structure and hold weights/biases for adjusting the feature values. In one embodiment, the deep learning model is a Convolutional Neural Network (CNN) that includes parameters specifying filters to be applied on individual features. Segregating the features allows the filter to focus on a particular feature to properly determine how that feature factors into the prediction. This is similar to how a CNN is used in image processing where a filter is applied to individual channels of an image. The CNN further includes parameters specifying weights (e.g., coefficients) in a function that combines the filtered values of each feature of the plurality of features and determines the number of orders for the financial service provider to execute by the future date.

In some instances, the financial service provider implements region-level forecasting by configuring the deep learning model to make predictions as to a number of orders to execute within a specific geographic region. For example, a global bank may want to predict the number of orders at county level. The deep learning model may leverage a temporal correlation between regional markets to accomplish region-level forecasting. The CNN structure allows for temporal alignment of market index features from different regions. In other instances, the financial service provider implements sub-market forecasting where only market indices associated with that sub-market are considered for the feature set used in predicting the number of orders to execute.

As described herein, the current reconstitution schedule can impact the prediction as to the number of orders to execute. Because the number of orders depends, in part, upon a market index's weighted average, exactly when (e.g., what day) that computation is made determines which weighted average is to be used to determine the number of orders to execute. Under instances when there is significant market shift, the CNN is able to adapt to the market shift automatically through an adaptive retrain process. For example, for a financial institution managing passive funds, its trading activity is highly affected by the reconstitution schedule of its benchmark index. When the benchmark index changes its reconstitution frequency, traditional prediction engines will fail or underperform. In contrast, the various embodiments described herein can adapt to such shifts and maintain performance As a result, the embodiments can improve affordability, scalability, modularity, extendibility, or interoperability for an operator, device or network.

With general reference to notations and nomenclature used herein, the detailed descriptions which follow may be presented in terms of program processes executed on a computer or network of computers. These process descriptions and representations are used by those skilled in the art to most effectively convey the substance of their work to others skilled in the art.

A process is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Various embodiments also relate to apparatus or systems for performing operations that are machine operations. This apparatus may be specially constructed for the required purpose or it may comprise a general purpose computer as selectively activated or reconfigured by a computer program stored in the computer. The processes presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

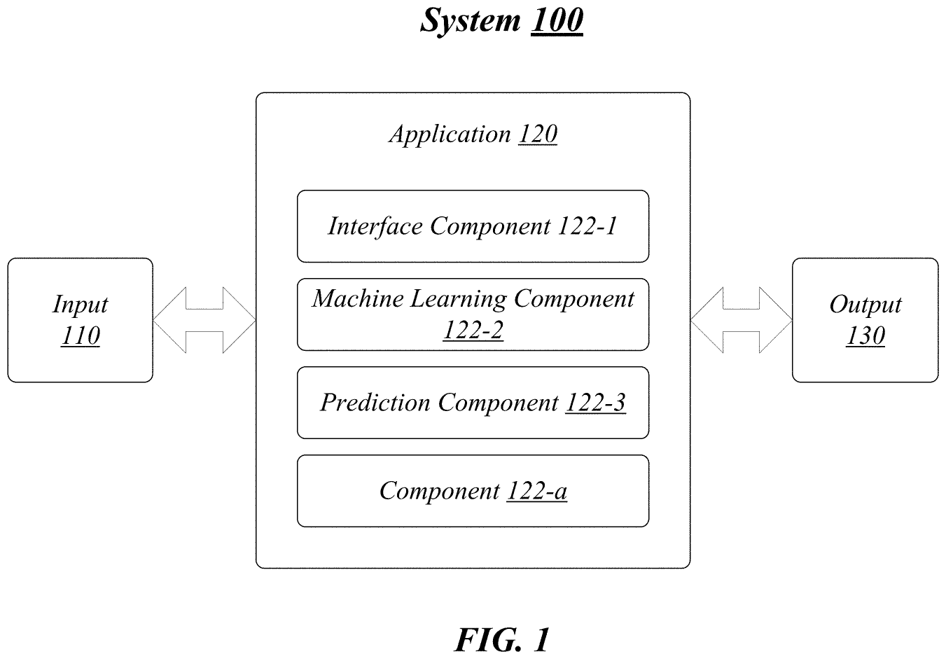

FIG. 1 illustrates a block diagram for a system 100. In one embodiment, the system 100 may comprise a computer-implemented system 100 having a software application 120 comprising one or more components 122-a. Although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The application 120 may be generally arranged to process input 110 of which some input may be provided directly to an interface component 122-1 via an input device, and other input may be provided to the interface component 122-1 via a network. For example, a user may enter data via a keyboard device attached to a computing device running the application 120. The application 120 may be generally arranged to generate output 130 for the interface component 122-1 of which some output may be configured for display on a display device and other output may be communicated across the network to other devices. As an example, the application 120 may generate data that can be processed/rendered by the interface component 122-1 into content for a Graphical User Interface (GUI).

In some embodiments, the application 120 is operative to provide users with forecasting services in a particular field, such as financial forecasting. The application 120 may invoke a machine learning component 122-2 to build, train, and/or operate a machine learning model (e.g., a deep learning model) configured to transform various historical data associated with a financial service provider into a prediction about future orders (e.g., trading orders) to a financial product or other asset. A proper prediction relies upon the machine learning model being accurate and, as described herein, conventional techniques (e.g., other models) have a number of issues including some related to accuracy; however, the machine learning model being implemented in accordance with the present disclosure mitigates and/or resolves at least some of (if not all) the number of issues.

In some embodiments, the machine learning model processes such historical data and identifies various features associated with forecasting order data for the financial service provider to execute at a future date. The machine learning model may specify one or more filters for application on each individual feature of the identified features. A filter typically includes a mathematical function that modifies a feature's values to analyze or identify a particular aspect of the machine learning model. In some embodiments, the machine learning model specifies a filter that when applied to a feature's values, determines whether (and to what degree) that feature's values factor into predicting an optimal number of orders to be executed by any given financial service provider at a future date. Those of ordinary skill appreciate the advantages and benefits stemming from segregating the features for individual analysis.

The application 120 may use the machine learning component 122-2 to build, train, and use the machine learning model to accomplish the above-mentioned forecasting services. In some embodiments, the application 120 utilizes an implementation of the machine learning model that includes a configuration of various parameters. Some parameters may specify which functions to use as the filters while other parameters may specify weights and/or biases for combining each filter's filtered values into a prediction about a number of orders (e.g., trading orders) to execute on or by the future date (e.g., a next day). The application 120 may utilize an implementation of the machine learning model that is built from parameters (e.g., weights and biases) corresponding to a deep learning structure (e.g., a neural network). These weights and biases may be used as coefficients in a function (e.g., a polynomial) that computes the number of orders for the financial service provider to execute at the future date. The machine learning model may also include hyperparameters for defining the machine learning model's implementation, for example by establishing a number of filters, a machine learning model architecture type (e.g., a convolution neural network (CNN)), a type of neural network (e.g., fully connected network), a maximum degree (i.e., an order) for the above-mentioned function for computing the predicted number of orders, and/or the like.

As described, the application 120 is designed for the financial service provider to use in making predictions about future orders. The financial service provider, via a prediction component 122-3 of the application 120, may configure the above-mentioned machine learning model regarding certain predictions. For example, the financial service provider may invoke the prediction component 122-3 to determine a number of orders to execute in general as well as in a given sub-market. The prediction component 122-3 may restrict the machine learning model to features associated with the sub-market. As another example, the financial service provider may invoke the prediction component 122-3 to determine a number of orders to execute in a particular geographic region. For this prediction, the prediction component 122-3 may instruct the machine learning component 122-2 to restrict the machine learning model to features associated with the particular geographic region.

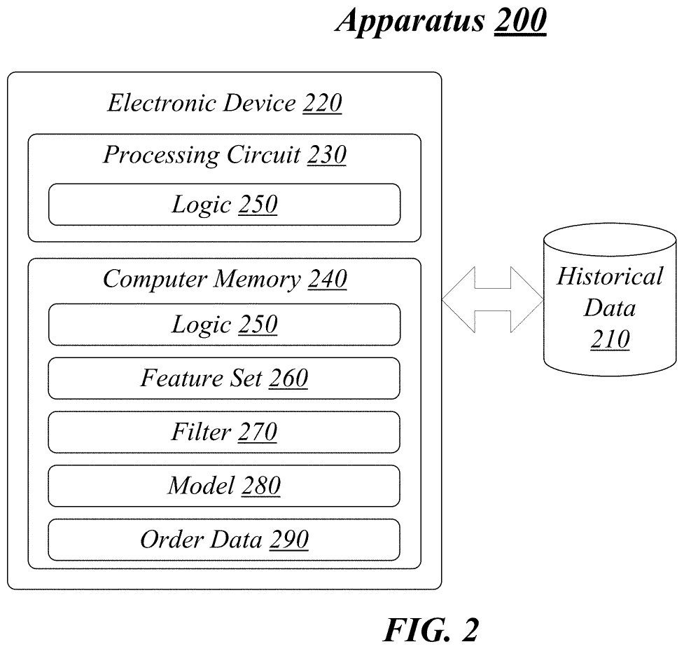

FIG. 2 illustrates an embodiment of an apparatus 200 for the system 100. As shown in FIG. 2, the apparatus 200 may be arranged into a single entity, an electronic 220, generally configured to process input and generate output. The electronic device 220 (or simply device 220) may process, as input, historical data 210 having various structured datasets. It is appreciated that the historical data 210 stores information describing various financial subjects, including the financial service provider's trading activities, financial markets in general, specific sub-markets and geographic regions, and/or the like.

The electronic device 220 includes a processing circuit 230 and computer memory 240 on which logic 250 is executed and stored, respectively. The logic 250 is operative to cause the processing circuit 230 to process the historical data 210 and identify different features and feature values in that data.

In some embodiments, the logic 250 is operative to cause the processing circuit to process a feature set 260 corresponding to the historical data 210 of a financial service provider. The feature set 260 may include a set of (feature) values for each feature of a plurality of features. In some embodiments, each feature's set of values in the feature set 260 includes time series data. The plurality of features may include one or more features corresponding to market index information and reconstitution information over a time period. An example feature may transform a market index reconstitution calendar/schedule into at least one feature value indicating an importance of the market index reconstitution calendar/schedule with respect to predicting an optimal number of orders to execute on a future date. In some embodiments, the logic 250 uses a metric for measuring a mathematical impact of the market index reconstitution calendar/schedule on next day's order. The mathematical impact indicates a reliability of a last weighted average and may be broken down by day to generate time series data for that feature. Hence, in some embodiments, the feature set 260 includes the time series data for indicating the market index reconstitution calendar/schedule's impact on the next day's order.

The logic 250 is further operative to cause the processing circuit 230 to apply a filter 270 (or, alternatively, filters) on the time series data for each feature of the plurality of features. The filter 270 may include a function (e.g., a polynomial function) configured to produce, from each feature's time series data, a set of filtered values of which each filtered value corresponds to a point-in-time in the time period. The logic 250 is operative to further cause the processing circuit to use a deep learning model 280 to combine each set of filtered values for the feature set and determine order data 290 indicating a number of orders for the financial service provider to execute on a future date.

The logic 250 is further operative to cause the processing circuit 230 to build the deep learning model 280 to include parameters for predicting an optimal number of orders to execute on a next day or another future date. The deep learning model 270, in general, implements a neural network architecture that relies upon the parameters to process sequence data as input and produce label data as output. In some embodiments, the model 270 configures the parameters into coefficients for a polynomial function that combines each feature's filtered values and computes a number of orders to execute at the future date.

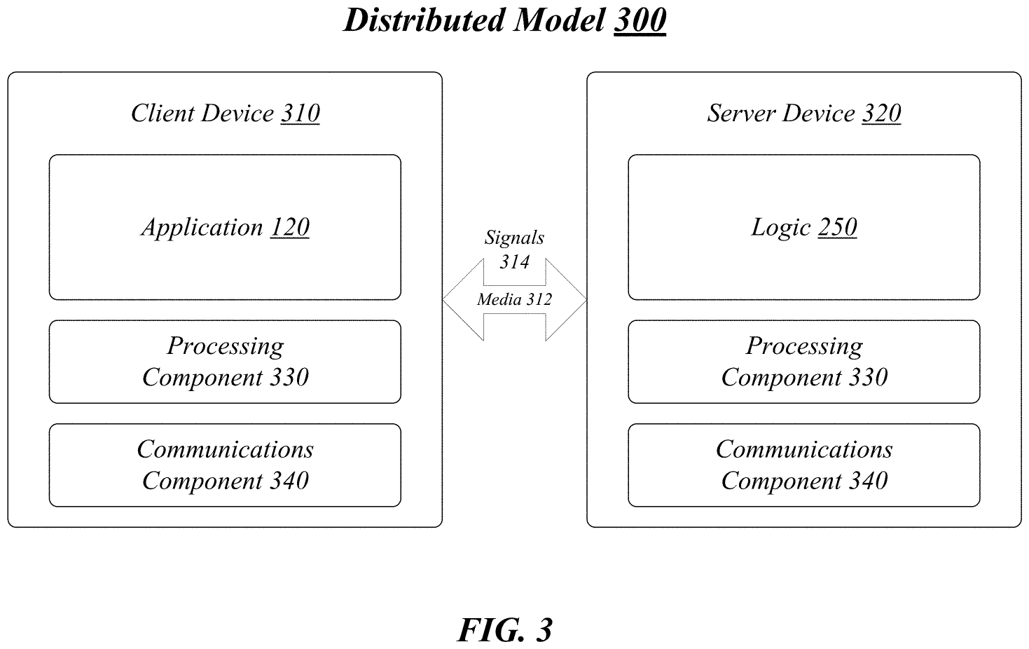

FIG. 3 illustrates a block diagram of a distributed model 300 for the system 100. The system 100 may be arranged into the distributed model 300 that distributes portions of the structure and/or operations for the system 100 across multiple computing entities. Examples of distributed model may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context. As an alternative, the distributed model 300 may implement some or all of the structure and/or operations for the system 100 in a single computing entity, such as entirely within a single electronic device.

The distributed system 300 may comprise a client device 310 and a server device 350. In general, the client device 310 and the server device 350 may be the same or similar to the apparatus 200 as described with reference to FIG. 2.

The client device 310 may comprise or employ one or more client programs that operate to perform various methodologies in accordance with the described embodiments. In one embodiment, for example, the client device 310 may implement the application 120 of FIG. 1 as a web application or a mobile application.

The server device 350 may comprise or employ one or more server programs that operate to perform various methodologies in accordance with the described embodiments. In one embodiment, for example, the server device 350 may implement the logic 250 of FIG. 2.

Each of the devices 310, 350 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The devices 310, 350 may execute processing operations or logic for the system 100 using a processing component 330. The processing component 330 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), Application-specific Standard Products (ASSPs), System-on-a-chip systems (SOCs), Complex Programmable Logic Devices (CPLDs), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, processes, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The devices 310, 350 may execute communications operations or logic for the system 100 using communications component 340. The devices 310, 350 may communicate over a communications media 314 using communications signals 312 via the communications component 340. The communications component 340 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 340 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 312 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

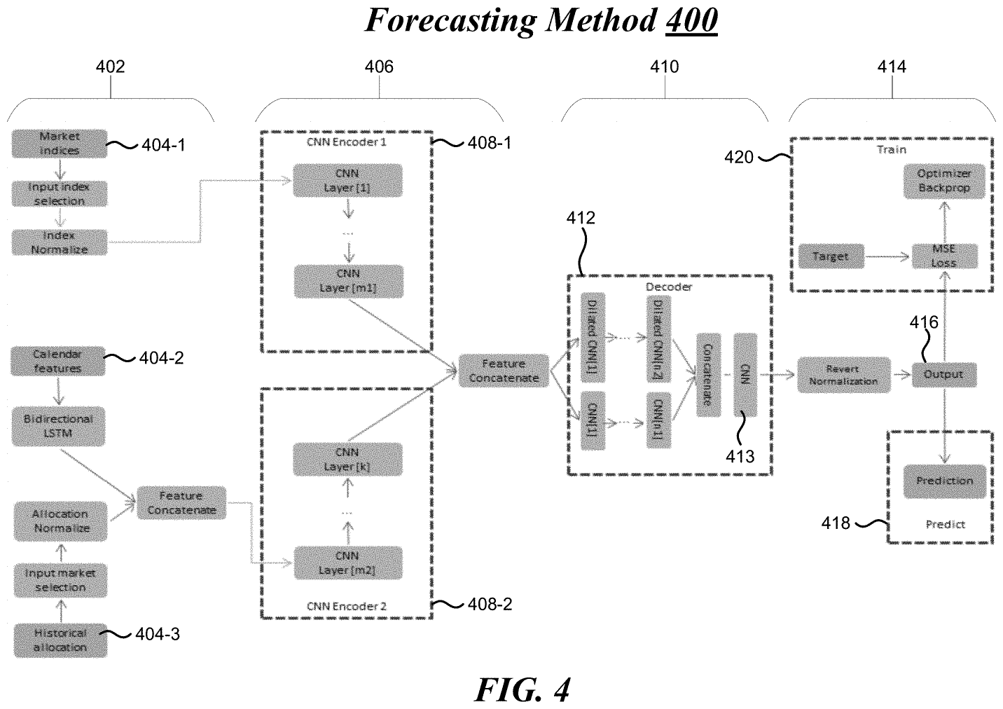

FIG. 4 illustrates an embodiment of a forecasting method 400 for the system 100. As shown in FIG. 4, the forecasting method 400 commences with a processing step 402 for transforming raw data (e.g., historical data) into features including those corresponding to market indices 404-1, calendar features 404-2, and historical allocation 404-3. After identifying these features in the raw data, the forecasting method 400 in the processing step 402 further processes the features to prepare feature data for filtering.

The market indices 402-1, for instance, undergo input index selection and index normalize sub-steps. In general, the market indices 402-1 refers to market index information for a number of different market indexes of which each market index is a weighted average of several stocks or other investment vehicles from a section of the stock market. That section may refer to a particular market or sub-market or a particular geographic region. Therefore, by enabling instant creation of any market index, the system 100 described herein provides a financial service provider with specific order predictions for any desired sub-market or geographic region. The financial service provider may enter input indicating which market index to create at the input index selection sub-step.

At the index normalize sub-step, the market index's weighted average is normalized for comparison with other market indexes. Each market index is calculated from the price of the selected stocks and is characterized by a volume of the selected stocks with respect to the entire stock market. That calculation is to be normalized to enable comparison with other market indexes. Hence, the set of normalized weighted averages at the end of the index normalize sub-step operate as benchmarks to gauge a performance of a current financial portfolio or product and predict the optimal number of orders to execute.

The calendar features 404-2 generally refer to a reconstitution schedule for the market indices 404-1. Therefore, the calendar features 404-2 includes time series data encompassing points-in-time of a time period associated with the reconstitution schedule. A bidirectional Long short-term memory (LSTM) is a type of machine learning model implementing an artificial recurrent neural network (RNN) architecture. The bidirectional LSTM is well-suited for classifying or making predictions based upon the time series data of the calendar features. In some embodiments, based upon the time series data, the bidirectional LSTM predicts a future reconstitution schedule. In some embodiments, the bidirectional LSTM classifies the time series data based upon the calendar features' impact on the weighted averages in the market indices 404-1. To illustrate by way of example, the weighted averages used for the market indices 404-1 are dependent on the reconstitution schedule and an optimal number of orders to execute for a point-in-time depends on the weighted averages; therefore, any change to the schedule effects the weighted averages and ultimately impacts any prediction as to optimal order data over the time period. Therefore, the bidirectional LSTM produces a set of values of which each value represents an impact of that value's point-in-time in the reconstitution schedule on the optimal number of orders to execute.

The historical allocation 404-3 includes historical order data by the financial service provider based upon at least one of the market indices 404-1. As described herein, the historical order data includes at least a number of orders executed at a particular point-in-time in the above-mentioned time period. An input market selection sub-step identifies market indices associated with a particular sub-market or market. At an allocation normalize sub-step, each identified market index's order data is normalized for comparison with other market indexes. At a feature concatenate sub-step, the above-mentioned set of values corresponding to the calendar features 404-2 is combined with a set of values corresponding to the normalized order data over the time period. In some embodiments, the bidirectional LSTM modifies an array of the time series data into an array of values where each value represents a relationship between the reconstitution schedule in effect at a particular point-in-time and the historical order data for that particular point-in-time and the identified market indices. Because both sets of values align into time slots corresponding to the same time period, the concatenated features values may resemble a two-dimensional array of values. The set of normalized weighted averages from the market indices 404-1 form another set of values that can be combined with the two-dimensional array of values to create a feature set. In some embodiments, the array of values of the bidirectional LSTM may be weights that adjust the normalized order data to represent the optimal number of orders for each point-in-time in the time period (i.e., optimal order data).

A filtering step 406 applies at least one filter on the values in the above-mentioned feature set. As illustrated in FIG. 4, the normalized weighted averages from the market indices 404-1 and the concatenated feature values from the calendar features 404-2 and the historical allocation 404-3 are fed into a CNN Encoder1 408-1 and a CNN encoder2 408-2, respectively. As described herein, a CNN Encoder refers to a filter (e.g., a function) that is applied to a set of feature values to produce a set of filtered values. The filter may be configured for a particular feature of the feature set such that the filter effectively models that particular feature's relationship to the optimal number of orders to execute. In other words, the filter models a pattern followed by the particular feature when making accurate predictions as to the optimal number of orders to execute. By segregating the normalized weighted averages from the concatenated feature values, the filter can mitigate or preclude the noise typically associated with filtering multiple features.

FIG. 4 depicts the CNN Encoder1 408-1 and the CNN Encoder2 408-2 as filtering feature values in a first CNN layer array and a second CNN layer array, respectively. Each element of the first CNN array refers to at least one normalized weighted average and each element of the second CNN array includes normalized order data that has been adjusted to indicate an optimal number of orders for a corresponding point-in-time. Both the CNN Encoder1 408-1 and the CNN Encoder2 408-2 generate first and second dilated CNN arrays of filtered feature values including filtered weighted averages and filtered order data, respectively.

After a feature concatenation sub-step combining elements of the first and second dilated CNN arrays and elements of the first and second CNN arrays, both concatenated arrays are processed during a convolution step 410 while being fed into a Decoder 412. In general, the Decoder 412 builds a CNN 413 by determining and then, applying parameters to compute an optimal number of orders to execute on a future date. As described herein, the CNN 413 arranges the parameters into a deep learning structure.

During a training step 414, the Decoder 412 provides the CNN and its deep learning structure of parameters as output 416. The training step 414, at a revert normalization sub-step, produces the output 416 by converting at least some of the parameter values into another numbering system or scale. The CNN 413 is directed to a predict 418 component of the training step where a prediction is made regarding an optimal number of orders to execute at a next day or another future date. When the next day or other future date arrives, the financial service provider executes the predicted number of orders. Another component of the training step 414, a train 420 component, uses the predicted number of orders to train the CNN 413 and improve upon an accuracy of future predictions. The train 420 component determine a target indicating an optimal number of orders that should have been executed. A difference between the target and the prediction may be considered a loss or error. The train 420 component compares the target with the prediction after each prediction made by the predict 418 component. Over time, the train 420 component computes a mean squared error (MSE) of the CNN by measuring an average of the squares of the differences between each day's target and prediction. The train 420 component uses the MSE to update the parameters of the CNN 413, thereby improving upon the CNN 413's accuracy.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

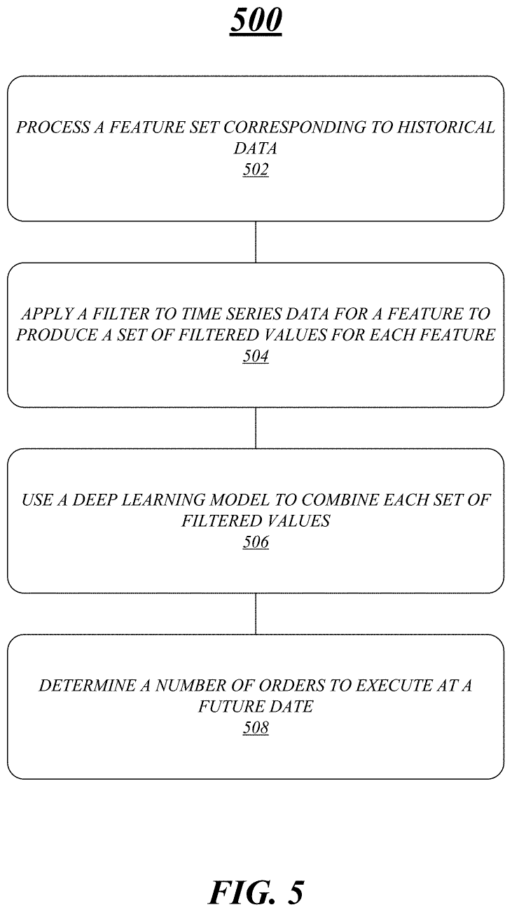

FIG. 5 illustrates one embodiment of a logic flow 500. The logic flow 500 may be representative of some or all of the operations executed by one or more embodiments described herein.

In the illustrated embodiment shown in FIG. 5, the logic flow 500 processes a feature set corresponding to a financial service provider at block 502. The feature set includes time series data for each feature of a plurality of features, and the time series data includes market index information, order data, and reconstitution information over a time period. As described herein, market index information refers (in part) to market index features, such as weighted averages of stock prices over a time period; the reconstitution information refers (in part) to calendar features, such as a reconstitution schedule encompassing the same time period; and the order data refers to historical allocation, such as historical orders by the financial service provider over the same time period. The weighted averages may pertain to more than one market index. For example, the feature set includes a set of weighted averages for a market index, a set of historical orders, and a set of weights corresponding to the reconstitution schedule. It is appreciated that those skilled in the art may use different features and/or additional features from the feature set.

The logic flow 500 may apply a filter on the time series data for at least one feature of the plurality of features at block 504. The filter includes at least one function configured to produce filtered values of which each filtered value corresponds to at least one point-in-time in the time period. For example, the logic flow 500 applies the filter to portions of a feature's time series data and computes a filtered value for each filtered portion. Hence, the filter's function accepts, as an input variable, each portion of the feature's time series data and generates, as an output variable, a filtered value for a particular point-in-time in the time period.

The logic flow 500 may use a deep learning model to combine the filtered values for the feature set and at block 506. For example, the deep learning model may be a CNN having parameters for a function (e.g., a polynomial). Once built and training, the CNN is fully-connected such that the CNN's function accepts, as input variables, the filtered values from the features in the feature set. The CNN's parameter may define weights for use in the CNN's function to combine the filtered values into a weighted average.

The logic flow 500 may determine a number of orders for the financial service provider to execute on a future date at block 508. In some embodiments, the logic flow 500 uses the weighted average of filtered feature values produced by the CNN's function as a prediction regarding the number of orders to execute. The financial service provider relies upon this prediction and on the future date, executes the determined number of orders. With the benefit of hindsight, the logic flow 500 may determine an actual optimal number of orders that should have been made and use that determination further train the CNN. The logic flow 500 may adjust the CNN's parameters to better fit the actual optimal number of orders and improve upon future predictions. The embodiments are not limited to this example.

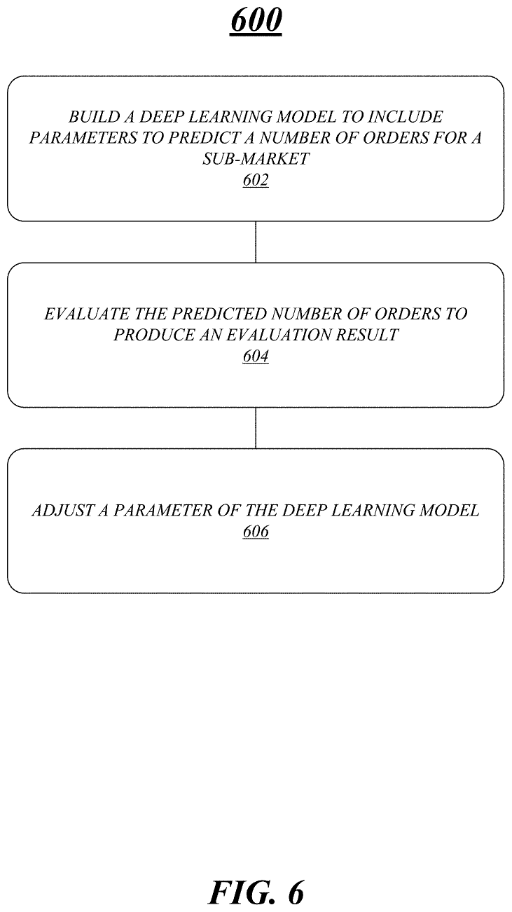

FIG. 6 illustrates one embodiment of a logic flow 600. The logic flow 600 may be representative of some or all of the operations executed by one or more embodiments described herein.

In the illustrated embodiment shown in FIG. 6, the logic flow 600 builds a deep learning model to include parameters to predict a number of orders for a sub-market at block 602. As described herein, at least one market index can be created to estimate the sub-market. The logic flow 600 may select the market index configured to optimize future order data. It is possible for the logic flow 600 to create a dynamic market index from stocks and other financial vehicles associated with the sub-market.

The logic flow 600 may evaluate the predicted number of orders to produce an evaluation result at block 604. For example, the logic flow 600 may compare the predicted number of orders with a target number of orders for the same point-in-time (e.g., same day) and a difference between these numbers may be included in the evaluation result. The target number of orders may represent an optimal number of orders in hindsight.

The logic flow 600 may adjust a parameter of the deep learning model at block 606. As described herein, the deep learning model may include parameters operative to run a forecasting method for the financial service provider. Some parameters select which filter(s) to apply on each set of feature values in a feature set (e.g., the feature set 260 of FIG. 2) while other parameters select which weights/biases to use when combining filtered feature values into a prediction regarding the number of orders for the sub-market. The logic flow 600 may adjust any of the above parameters to improve upon future predictions. The embodiments are not limited to this example.

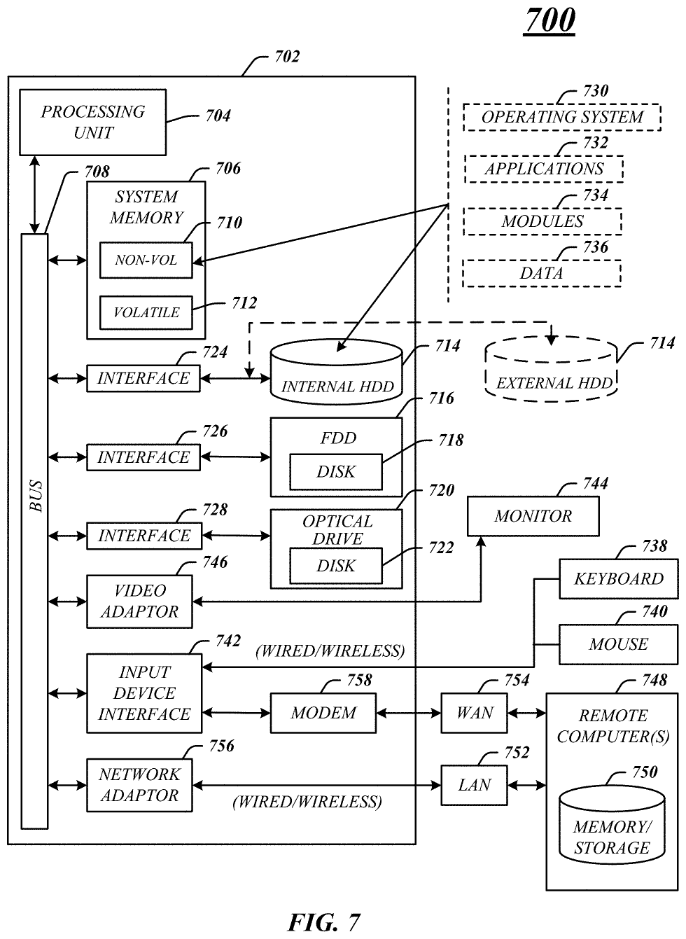

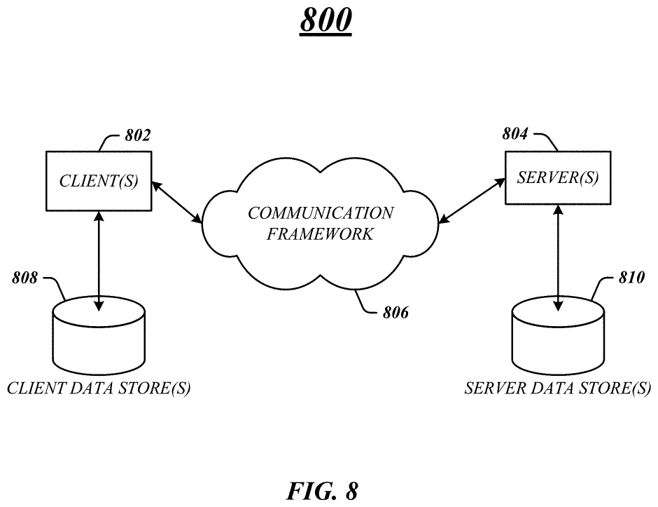

FIG. 7 illustrates an embodiment of an exemplary computing architecture 700 suitable for implementing various embodiments as previously described. In one embodiment, the computing architecture 700 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

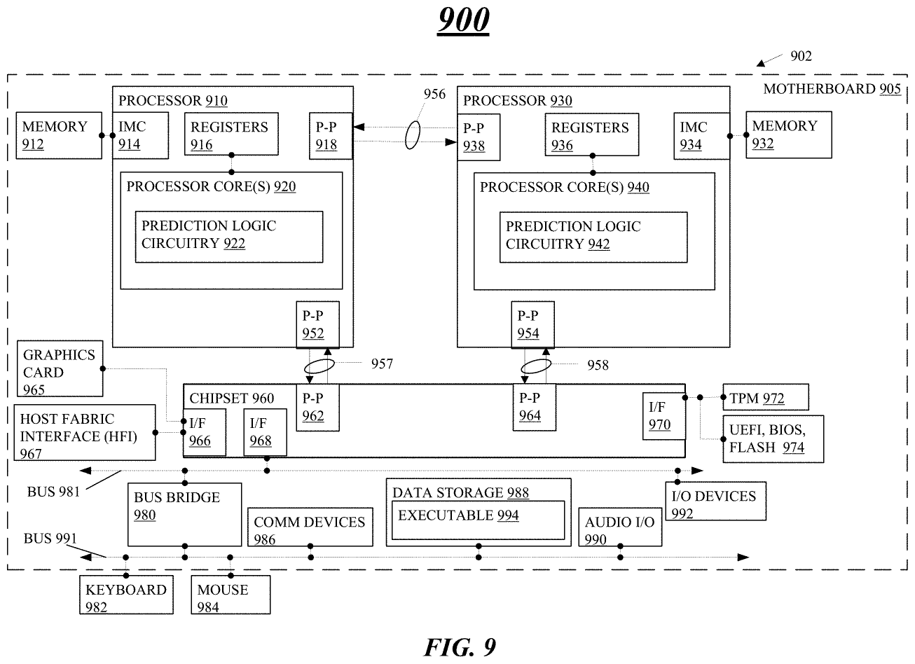

As shown in FIG. 7, the computing architecture 700 comprises a processing unit 704, a system memory 706 and a system bus 708. In some embodiments, there may be a chipset (as shown in FIG. 9) residing between the processing unit 704 and the system bus 708 and the system memory 706. The processing unit 704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 704.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 comprises includes one or more clients 802 and servers 804. The clients 802 may implement the client device 910. The servers 804 may implement the server device 950. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques and protocols. The communications framework 806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

As shown in FIG. 9, system 900 comprises a motherboard 905 for mounting platform components. The motherboard 905 is a point-to-point interconnect platform that includes a first processor 910 and a second processor 930 coupled via a point-to-point interconnect 956 such as an Ultra Path Interconnect (UPI). In other embodiments, the system 900 may be of another bus architecture, such as a multi-drop bus. Furthermore, each of processors 910 and 930 may be processor packages with multiple processor cores including processor core(s) 920 and 910, respectively. While the system 900 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 910 and the chipset 960. Some platforms may include additional components and some platforms may only include sockets to mount the processors and/or the chipset.

In some embodiments, the processor core(s) 920 and 940 may comprise prediction logic circuitry 922 and 942 such as the logic 250 described in conjunction with FIGS. 2, 1C and 2. The prediction logic circuitry may comprise processing circuitry configured for perform the operations described for the processing circuit 230 and the processing component 330 described in conjunction with FIGS. 2 and 3, respectively.

The first processor 910 includes an integrated memory controller (IMC) 914 and point-to-point (P-P) interfaces 918 and 952. Similarly, the second processor 930 includes an IMC 934 and P-P interfaces 938 and 954. The IMC's 914 and 934 couple the processors 910 and 930, respectively, to respective memories, a memory 912 and a memory 932. The memories 912 and 932 may be portions of the main memory (e.g., a dynamic random-access memory (DRAM)) for the platform (such as the main memory 478 in FIG. 4) such as double data rate type 3 (DDR3) or type 4 (DDR4) synchronous DRAM (SDRAM). In the present embodiment, the memories 912 and 932 locally attach to the respective processors 910 and 930. In other embodiments, the main memory may couple with the processors via a bus and shared memory hub.

The processors 910 and 930 comprise caches coupled with each of the processor core(s) 920 and 940, respectively. The first processor 910 couples to a chipset 960 via P-P interconnects 952 and 962 and the second processor 930 couples to a chipset 960 via P-P interconnects 954 and 964. Direct Media Interfaces (DMIs) 957 and 958 may couple the P-P interconnects 952 and 962 and the P-P interconnects 954 and 964, respectively. The DMI may be a high-speed interconnect that facilitates, e.g., eight Giga Transfers per second (GT/s) such as DMI 3.0. In other embodiments, the processors 910 and 930 may interconnect via a bus.

The chipset 960 may comprise a controller hub such as a platform controller hub (PCH). The chipset 960 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 960 may comprise more than one controller hub such as a chipset with a memory controller hub, a graphics controller hub, and an input/output (I/O) controller hub.

In the present embodiment, the chipset 960 couples with a trusted platform module (TPM) 972 and the UEFI, BIOS, Flash component 974 via an interface (I/F) 970. The TPM 972 is a dedicated microcontroller designed to secure hardware by integrating cryptographic keys into devices. The UEFI, BIOS, Flash component 974 may provide pre-boot code.

Furthermore, chipset 960 includes an I/F 966 to couple chipset 960 with a high-performance graphics engine, graphics card 965 and a host fabric interface (HFI) 967. The I/F 966 may be, for example, a Peripheral Component Interconnect-enhanced (PCI-e). The HFI 967 may include a network interface to couple the system 900 with a connectivity fabric. The HFI 967 may be a network interface card (NIC) coupled with the system 900 or may comprise a portion of an integrated circuit of the chipset 960 or of a processor such as the processor 910 and/or the processor 930. The HFI 967 may interface the system 900 with other systems or storage devices such as the apparatus 200 illustrated in FIG. 2 via a connectivity fabric such as Fibre Channel or the like.

Various I/O devices 992 couple to the bus 981, along with a bus bridge 980 which couples the bus 981 to a second bus 991 and an I/F 968 that connects the bus 981 with the chipset 960. In one embodiment, the second bus 991 may be a low pin count (LPC) bus. Various devices may couple to the second bus 991 including, for example, a keyboard 982, a mouse 984, communication devices 986, and a data storage unit 988 that may store code. Furthermore, an audio I/O 990 may couple to second bus 991. Many of the I/O devices 992, the communication devices 986, and the data storage unit 988 may reside on the motherboard 905 while the keyboard 982 and the mouse 984 may be add-on peripherals. In other embodiments, some or all the I/O devices 992, communication devices 986, and the data storage unit 988 are add-on peripherals and do not reside on the motherboard 905. In some embodiments, the data storage unit 988 may comprise a prediction executable 994 that can execute of a processor core such as the processor core(s) 920 and 940 to configure prediction logic circuitry 922 and 942.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processing circuit; and
logic stored in computer memory and executed on the processing circuit, the logic operative to cause the processing circuit to:
process a feature set corresponding to historical data of a financial service provider, the feature set comprising time series data for each feature of a plurality of features, at least two of the plurality of features corresponding to a market index and a reconstitution schedule over a time period;
apply a filter on the time series data for each feature of the plurality of features, the filter comprising at least one function configured to produce a set of filtered values of which each filtered value corresponds to a point-in-time in the time period; and
use a deep learning model to combine each set of filtered values for the feature set and determine a number of orders for the financial service provider to execute on a future date.

2. The apparatus of claim 1, comprising apply a filter to portions of the time series data for the at least one feature of the feature set, each portion encompassing a portion of the time period, and compute a filtered value for each filtered portion.

3. The apparatus of claim 1, comprising build the deep learning model to include parameters configured to predict the number of orders based upon the historical data.

4. The apparatus of claim 3, comprising train the deep learning model by evaluating the predicted number of orders to produce an evaluation result and adjusting at least one filter in response to the evaluation result.

5. The apparatus of claim 3, comprising train the deep learning model by evaluating the predicted number of orders to produce an evaluation result and updating at least one parameter in response to the evaluation result.

6. The apparatus of claim 1, comprising determining the number of orders for a particular geographic region or a particular sub-market.

7. The apparatus of claim 1 wherein the deep learning model is a convolutional neural network.

8. A computer-implemented method executed on at least one processing circuit, comprising:
processing a feature set corresponding to a financial service provider, the feature set comprising time series data for each feature of a plurality of features, at least two of the plurality of features corresponding to market index information and reconstitution information over a time period;
applying a filter on the time series data for at least one feature of the plurality of features, the filter comprising at least one function configured to produce filtered values of which each filtered value corresponds to at least one point-in-time in the time period; and
using a deep learning model to combine the filtered values for the feature set and determine a number of orders for the financial service provider to execute on a future date.

9. The computer-implemented method of claim 8, comprising apply a filter to portions of the time series data for the at least one feature of the feature set and compute a filtered value for each filtered portion.

10. The computer-implemented method of claim 9, comprising training the deep learning model by evaluating the determined number of orders to produce an evaluation result and adjusting at least one filter in response to the evaluation result.

11. The computer-implemented method of claim 9, comprising building the deep learning model to include parameters configured to predict the number of orders based upon the historical data and training the deep learning model by evaluating the predicted number of orders to produce an evaluation result and updating at least one parameter in response to the evaluation result.

12. The computer-implemented method of claim 8, comprising determining the number of orders for a particular geographic region.

13. The computer-implemented method of claim 8, comprising determining the number of orders for a particular sub-market.

14. The computer-implemented method of claim 8 wherein the deep learning model comprises a convolutional neural network.

15. At least one computer-readable storage medium comprising instructions that, when executed, cause a system to:
process a feature set corresponding to a financial service provider, the feature set comprising time series data for each feature of a plurality of features, at least two of the plurality of features corresponding to a market index and a reconstitution schedule over a time period;
apply at least one filter on the time series data for at least one feature of the plurality of features, the at least one filter comprising at least one function configured to produce filtered values of which each filtered value corresponds to at least one point-in-time in the time period; and
using a deep learning model to combine the filtered values for the feature set and determine a number of orders for the financial service provider to execute on a future date.

16. The computer-readable storage medium of claim 15, comprising instructions that when executed cause the system to apply a filter to portions of the time series data for the at least one feature of the feature set, each portion encompassing a portion of the time period, and compute a filtered value for each filtered portion.

17. The computer-readable storage medium of claim 15, comprising instructions that when executed cause the system to train the deep learning model by evaluating the predicted number of orders to produce an evaluation result and adjusting the at least one filter in response to the evaluation result.

18. The computer-readable storage medium of claim 15, comprising instructions that when executed cause the system to build the deep learning model to include parameters configured to predict the number of orders and train the deep learning model by evaluating the predicted number of orders to produce an evaluation result and adjusting at least one parameter in response to the evaluation result.

19. The computer-readable storage medium of claim 15, comprising instructions that when executed cause the system to determine the number of orders for a particular geographic region.

20. The computer-readable storage medium of claim 15, comprising instructions that when executed cause the system to determine the number of orders for a particular sub-market.
